(19) United States
(12) Patent Application Publication
(10) Pub. No.: US 2022/0343038 A1
(43) Pub. Date: Oct. 27, 2022

(54) VEHICLE SIMULATOR

(71) Applicant: FORD GLOBAL TECHNOLOGIES, LLC, Dearborn, MI (US)

(72) Inventors: Di ZHU, Canton, MI (US); Benjamin A. TABATOWSKI-BUSH, Ann Arbor, MI (US)

(73) Assignee: FORD GLOBAL TECHNOLOGIES, LLC, Dearborn, MI (US)

(21) Appl. No.: 17/238,705

(22) Filed: Apr. 23, 2021

(51) Int. Cl. G06F 30/20; G06F 30/15; G06F 30/12

(52) U.S. Cl. CPC G06F 30/20; G06F 30/15; G06F 30/12

(57) ABSTRACT

A server includes a processor, programmed to responsive to a user selecting a vehicle for simulation, identify a minimum requirement and a preferred requirement for a plurality of features associated with the vehicle, obtain information of user hardware including a computing device and a mobile device in communication with each other, responsive to verifying the user hardware meets the preferred requirement for a first feature of the plurality of features, list the first feature on top of a feature list, and responsive to the user selecting the first feature, perform a simulation of the first feature via the computing device and the mobile device.

### TECHNICAL FIELD

The present disclosure generally relates to a vehicle simulator. More specifically, the present disclosure relates to a system and method for simulating vehicle features.

### BACKGROUND

Vehicle manufacturers may provide an interactive interface (e.g. on a website) to allow potential buyers to configure and experience new vehicles. For instance, the user may browse the manufacturer website using a computer and select the model and features of the desired vehicle. The website may provide information about the desired vehicle based on the user configuration. Some manufacturers provide driving simulators equipped with dedicated hardware (e.g., at a dealership) to provide a more comprehensive test drive experience to the buyers.

### SUMMARY

In one or more exemplary embodiments of the present disclosure, a server includes a processor, programmed to responsive to a user selecting a vehicle for simulation, identify a minimum requirement and a preferred requirement for a plurality of features associated with the vehicle, obtain information of user hardware including a computing device and a mobile device in communication with each other, responsive to verifying the user hardware meets the preferred requirement for a first feature of the plurality of features, list the first feature on top of a feature list, and responsive to the user selecting the first feature, perform a simulation of the first feature via the computing device and the mobile device.

In one or more exemplary embodiments of the present disclosure, a computing device includes a network controller programmed to communicate with a server; a wireless transceiver programmed to communicate with a mobile device; a human-machine interface (HMI); and a simulation controller programmed to responsive to a user selecting, via the HMI, a vehicle to simulate, communicate with the server to identify a minimum requirement and a preferred requirement for a plurality of features associated with the vehicle, examine user hardware information indicative of a specification of the computing device and the mobile device and compare the user hardware information with the minimum and preferred requirements, responsive to verifying the user hardware information meets the preferred requirement for a first feature of the plurality of features, list the first feature on top of a feature list, and responsive to the user selecting the first feature, perform a simulation of the first feature by outputting a first simulation interface via the HMI and a second simulation interface via the mobile device.

In one or more exemplary embodiments of the present disclosure, a method for a vehicle simulation system includes responsive to receiving an input from a user indicative of a selection a vehicle to simulate, identify a minimum requirement and a preferred requirement for a plurality of features associated with the vehicle; obtaining information of user hardware including a computing device, a mobile device, and an input/output (I/O) device associated with the user; comparing the user information with the minimum and preferred requirements; responsive to verifying the user hardware meets the preferred requirement for a first feature of the plurality of features, listing the first feature on top of a feature list; responsive to verifying the user hardware meets the minimum requirement and insufficient for the preferred requirement of a second feature, listing the second feature on the list below the first feature; and responsive to the user selecting the first feature, performing a simulation of the first feature by receiving input via the I/O device, and outputting a first simulation interface via the HMI and a second simulation interface via the mobile device.

### BRIEF DESCRIPTION OF THE DRAWINGS

For a better understanding of the invention and to show how it may be performed, embodiments thereof will now be described, by way of non-limiting example only, with reference to the accompanying drawings, in which:

FIG. 1 illustrates an example block topology of a vehicle simulator system of one embodiment of the present disclosure;

FIG. 2 illustrates an example flow diagram of a process for simulating vehicle features of one embodiment of the present disclosure;

FIG. 3 illustrates an example flow diagram of a process for simulating vehicle features of another embodiment of the present disclosure; and

FIG. 4 illustrates an example diagram of a vehicle simulation interface of one embodiment of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present disclosure generally provides for a plurality of circuits or other electrical devices. All references to the circuits and other electrical devices, and the functionality provided by each, are not intended to be limited to encompassing only what is illustrated and described herein. While particular labels may be assigned to the various circuits or other electrical devices, such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programed to perform any number of the functions as disclosed.

The present disclosure, among other things, proposes a vehicle simulator system. More specifically, the present disclosure proposes a vehicle simulator system involving multiple hardware devices coordinated by a cloud server to improve user experience.

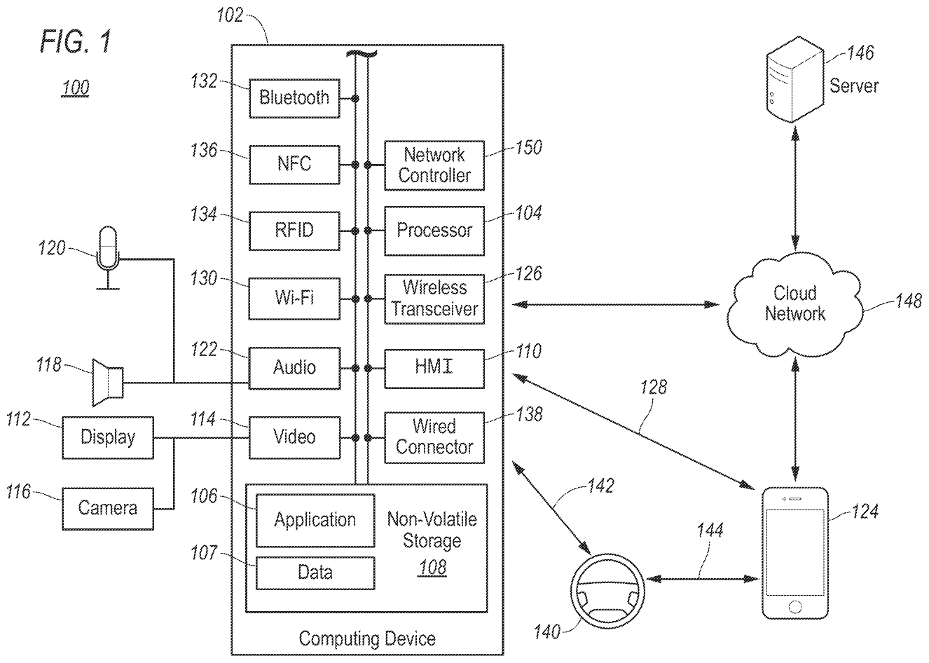

Referring to FIG. 1, an example block topology of a vehicle simulation system 100 of one embodiment of the present disclosure is illustrated. The vehicle simulation system 100 may include a computing device 102 having one or more processors 104 configured to perform instructions, commands, and other routines in support of the processes described herein. As a few non-limiting examples, the computing device 102 may be include one or more of a desktop computing, a laptop, a tablet computer, a smart phone, an infotainment system of a vehicle or the like configured to perform various operations. For instance, the computing device 102 may be configured to execute instructions of simulator applications 106 to provide features such as vehicle feature simulation and communication. Such instructions and other data 107 may be maintained in a non-volatile manner using a variety of types of computer-readable medium 108. The computer-readable medium 108 (also referred to as a processor-readable medium or storage) includes any non-transitory medium (e.g. tangible medium) that participates in providing instructions or other data that may be read by the processor 104 of the computing device 102. Computer-executable instructions may be compiled or interpreted from computer programs created using a variety of programming languages and/or technologies, including, without limitation, and either alone or in combination, Java, C, C++, Objective C, Fortran, Pascal, Java Script, Python, Perl, and PL/SQL.

The computing device 102 may be provided with various features allowing users to interface with the computing device 102. For instance, the computing device 102 may receive input from human-machine interface (HMI) controls 110 configured to provide for user interaction with the computing device 102. The computing device 102 may further communicate with one or more displays 112 configured to provide visual output to a user by way of a video controller 114. In some cases, the display 112 may be provided with touch screen features configured to receive user touch input via the video controller 114, while in other cases the display 112 may be a display only, without touch input capabilities. The display 112 may be a liquid-crystal display (LCD), active-matric organic light-emitting diode display (AMOLED), a head up display (HUD), a projector, virtual reality (VR) glasses, augmented reality (AR) glasses, or mixed reality (MR) glasses as a few non-limiting examples. The computing device 102 may further communicate with one or more cameras 116 configured to capture images/videos as input by way of the video controller 114. The computing device 102 may further drive or otherwise communicate with one or more speakers 118 and microphone 120 configured to provide audio output and input by way of an audio controller 122.

The computing device 102 may be further configured to wirelessly communicate with a mobile device 124 via a wireless transceiver 126 through a wireless connection 128. The mobile device 124 may be any of various types of portable computing device, such as cellular phones, tablet computers, wearable devices, smart watches, laptop computers, vehicle scan tool, or other device capable of communication with the computing device 102. the wireless transceiver 126 may be in communication with a Wi-Fi controller 130, a Bluetooth controller 132, a radio-frequency identification (RFID) controller 134, a near-field communication (NFC) controller 136, and other controllers such as a Zigbee transceiver, an IrDA transceiver (not shown), and configured to communicate with a compatible wireless transceiver (not shown) of the mobile device 124. The wireless connection 128 may be established in the form of a direct connection. Alternatively, the wireless connection 128 may be established indirectly such as the via a Wi-Fi router to which both the computing device 102 and the mobile device 124 are connected. Additionally or alternatively, the computing device 102 may be configured to communicate with the mobile device via a wired connector 138 through a cable. The wired connector may be configured to support various connection protocols including universal serial bus (USB), Ethernet, or on-board diagnostics 2 (OBD-II) as a few non-limiting examples. The computing device 102 may interface with one or more input/output (I/O) devices 140 (a.k.a., peripheral devices) via a wired or wireless connection 142 through the wireless transceiver 126 or the wired connector 138. Additionally or alternatively, the I/O device 140 may be further configured to communicate with the mobile device 124 via a wireless or wired connection 144. The I/O device 140 may include various hardware devices supported by the computing device 102 and/or the mobile device 124 and configured to interact with the user to simulate a vehicle environment. As a few non-limiting examples, the I/O device 140 may include a keyboard, a mouse, a trackball, a joystick, a steering wheel, accelerator/brake pedals, VR glasses or the like.

The computing device 102 may be further configured to communicate with one or more remote servers 146 via a cloud network 148 via a network controller 150. The server 146 may be associated with various entities such as a vehicle manufacturer providing the vehicle simulation. The terms cloud and server are used as a general terms in the present disclosure and may include any computing and communicating network and devices including hardware such as computers, devices, controllers or the like operated by software configured to perform data processing and storage functions and facilitate communication between various parties.

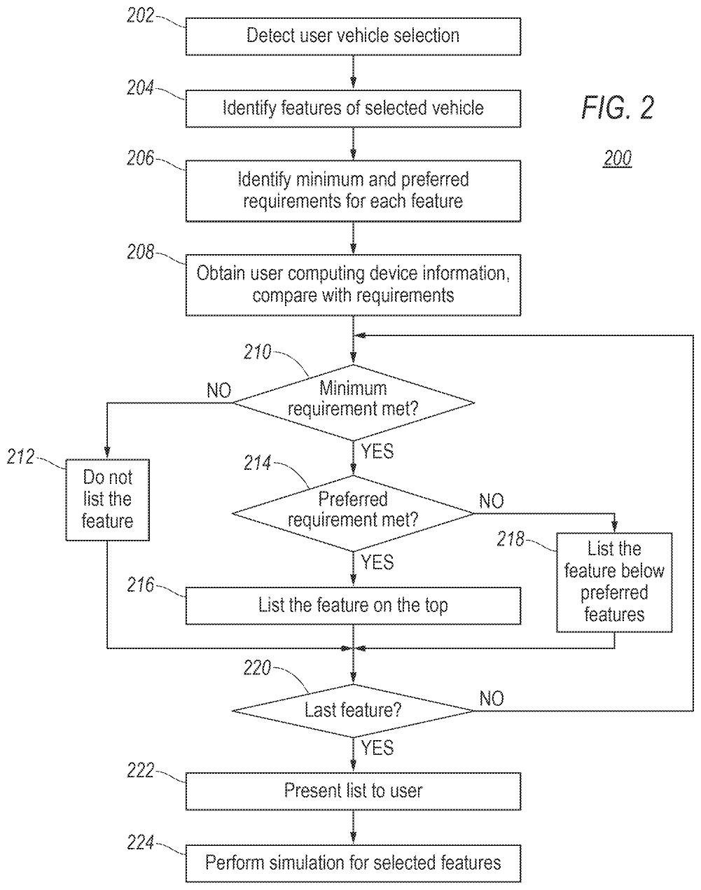

Referring to FIG. 2, an example flow diagram of a process 200 for simulating vehicle features of one embodiment of the present disclosure is illustrated. With continuing reference to FIG. 1, the process 200 may be generally implemented via the vehicle simulation system 100. More specifically, the process 200 may be individually or collectively implemented via the server 146, the computing device 102, and/or the mobile device 124. The following description will be made with reference to the server 146 for simplicity purposes. Responsive to detecting a user accessing the simulation system 100 with the computing device 102 and selecting a vehicle among a plurality of candidate vehicles to simulate at operation 202, the server 146 identifies a plurality of feature of the selected vehicle at operation 204. Each candidate vehicle may be associated with various features supported by the simulation system. For instance, the features may include parking assist, powertrain selection, surrounding view camera, lane keep assist or the like. At operation 206, the server 146 identifies a minimum requirement and a preferred requirement associated with each feature for simulation. The minimum and preferred requirements may be related to hardware and/or software configurations of the computing device 102 as well as the mobile device 124 and the I/O device 140 associated with the computing device 102. While the minimum requirement may allow the user to perform a basic simulation of the vehicle features, the preferred requirement may provide an improved user experience and/or a more vehicle-representative user experience for the simulation. In general, the preferred requirement is a higher requirement compared with the minimum requirement for a same feature to provide the user with an improved user experience. At operation 208, the server 146 obtains the configuration and status information of the computing device 102 and compare the information with the minimum and preferred requirements associated with each identified feature.

Each feature may have different minimum and preferred requirements. The server 146 may be configured to perform the requirement verification for each feature individually. At operation 210, if the server determines the configurations of the computing device 102 as well as the associated mobile device 124 and I/O device 140 do not meet the minimum requirement associated with a current feature being verified, the process proceeds to operation 212 to ignore the current feature. In other words, the server 146 may not list the current feature as a simulation option in a feature list to present to the user. If the server 146 determines the configurations of the computing device 102 as well as the associated mobile device 124 and I/O device 140 meet the minimum requirement associated with the current feature being verified, the process proceeds to operation 214 to further determine if the configurations meet the preferred requirement. If the server 146 determines the preferred requirement is met, the process proceeds to operation 216 to list the current feature on the top of the feature list as a preferred feature to encourage the user to try it out. Otherwise, if the configurations do not meet the preferred requirement, the process proceeds to operation 218 and the server 146 list the current feature on the feature list below the preferred features if there is any. At operation 220, the server 146 verifies if the current feature that has just been verified is the last feature associated with the selected vehicle. If the answer is a no, the process returns to operation 210 to verify the next feature. Otherwise, the process proceeds to operation 222 to present the feature list to the user. At operation 224, responsive to the user selecting a feature on the feature list, the server performs the simulation for the selected feature by interacting with the user via the computing device 102 as well as the mobile device 124 and the I/O device 140.

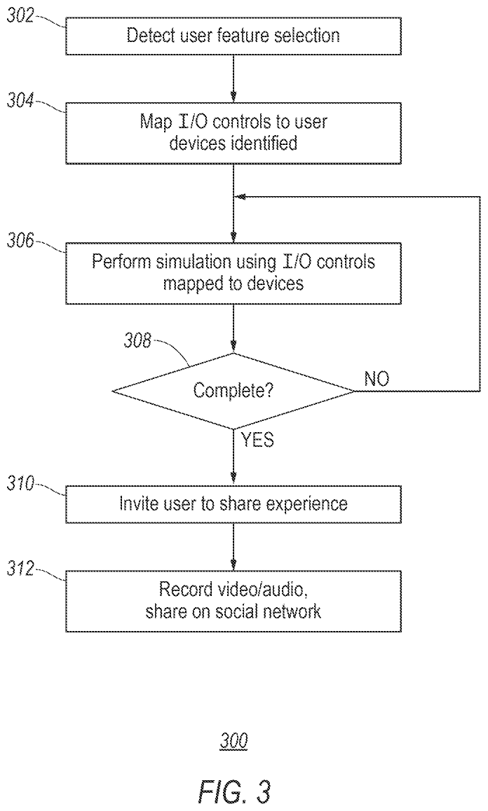

Referring to FIG. 3, an example flow diagram of a process 200 for simulating vehicle features of another embodiment of the present disclosure is illustrated. With continuing reference to FIGS. 1 and 2, similar to the process 200, the process 300 may be implemented individually or collectively via components of the vehicle simulation system 100. For instance, the process 300 may be individually or collectively implemented via the server 146, the computing device 102, and/or the mobile device 124. At operation 302, responsive to detecting a user selecting a feature from the feature list, the process proceeds to operation 304 and the server 146 maps the I/O controls to the user devices as identified. In the present example, the user devices may include the computing device 102, the I/O device 140 and the mobile device 124. The server 146 may automatically map the video output to the display 112 of the computing device 102 and/or the display of the mobile device 124, and the audio output to the speaker 118 of the computing device 102 and/or the speaker of the mobile device 124. The server 146 may further map the input controls to the HMI controls 110 of the computing device 102, the I/O device 140, and/or the touchscreen of the mobile device 124. At operation 306, the server 146 performs and coordinates the simulation via the input and output devices as mapped. Responsive to detecting the user has completed the simulation at operation 308, the process proceeds to operation 310 and the server 146 outputs a message to invite the user to share the simulation experience. Responsive to the user accepting the invitation, the server 146 coordinates a user device (e.g., the mobile device 124) to record a video and/or audio user review to share the experience to a social network or to a designated network. The server 146 may be further configured to edit the review by combining the user video/audio onto a video of the simulation that was performed by the user to provide a more comprehensive user review. In an alternative embodiment, the simulation system 100 may be configured to allow the user to record the video/audio review while performing the simulation and combine the simulation with the user review in a real-time manner to improve the effect of the user review. For instance, the server 146 may be configured to generate the video review in a “picture-in-picture” manner by superimposing an inset window displaying the user video onto a main window displaying the simulation video combined with the user audio commenting the simulation. Additionally, upon a user permission, the server 146 may collect the user data related to the simulation just performed such as what features have been simulated by the user and how the user uses the feature in the virtual environment and use the data in the review.

The operations of the processes 200 and 300 may be applied to various situations. For instance, a potential vehicle buyer may access the server 146 associated with the vehicle manufacturer's website using a computing device 102 (e.g., a laptop computer). Responsive to the user selecting a target vehicle such as by specifying model, year, and/or trim, the server 146 may perform a hardware and software test to the computing device 102 to obtain available information to configure the feature simulation. The server 146 may request the computing device 102 to send over the basic specification information such as processor model, memory size, touch screen support, operating system or the like. Additionally, the server 146 may further request the computing device to identify any other associated devices to further evaluate any possible options to provide an improved user experience during the simulation. For instance, the mobile device 124 (e.g., a tablet or a cell phone) may be connected to the computing device 102 under the same Wi-Fi network. One or more I/O devices 140 (e.g., a gaming steering wheel and pedals) may be connected with the computing device 102 via a wired connector. In this case, both the mobile device 124 and the I/O devices 140 may be identified as being associated with the computing device 102 which may be used to perform the vehicle feature simulation to improve user experience. Each vehicle feature supported by the simulation system 100 may have different requirements. For instance, while a steering wheel type I/O device 140 may be a preferred requirement for the vehicle parking assist feature to simulate the parking maneuver, the steering wheel type I/O device 140 may not be used in a vehicle acceleration simulation. The same preferred device may be operated in various manners in different simulations. In a parking assist simulation, the main display 112 of the computing device 102 may be used to output a simulated driving environment (e.g., front street view), the display of the mobile device 124 may be used to display image of a simulated backup camera or surrounding view camera view to provide the user with a more comprehensive simulation of the parking assist feature. In other simulations, the display of the mobile device 124 may be used to output a simulated instrument panel or infotainment system. Taking the parking assist feature simulation for instance, the server 146 may map the steering and brake control to the steering wheel and pedals as a part of I/O devices 140 connected to the computing device 102. The server 146 may map a gear selector rotor knob onto a keyboard or onto a touchscreen display 112 to allow the user to shift gears. The main display 112 may be mapped to display a simulated front view from a vehicle windshield. The mobile device 124 may be mapped to simulate an infotainment display when the forward gear is selected, and mapped to simulate a backup camera or surrounding via camera view when the user shifts to reverse which corresponds to a park assist feature in real life such that a more realistic feature simulation may be provide to the user. The simulation system 100 may further allow the user to record review including a video and/or audio of the user while performing the operation such that user comments recorded in a real-time manner may be posted onto the internet to encourage other users to perform the simulation.

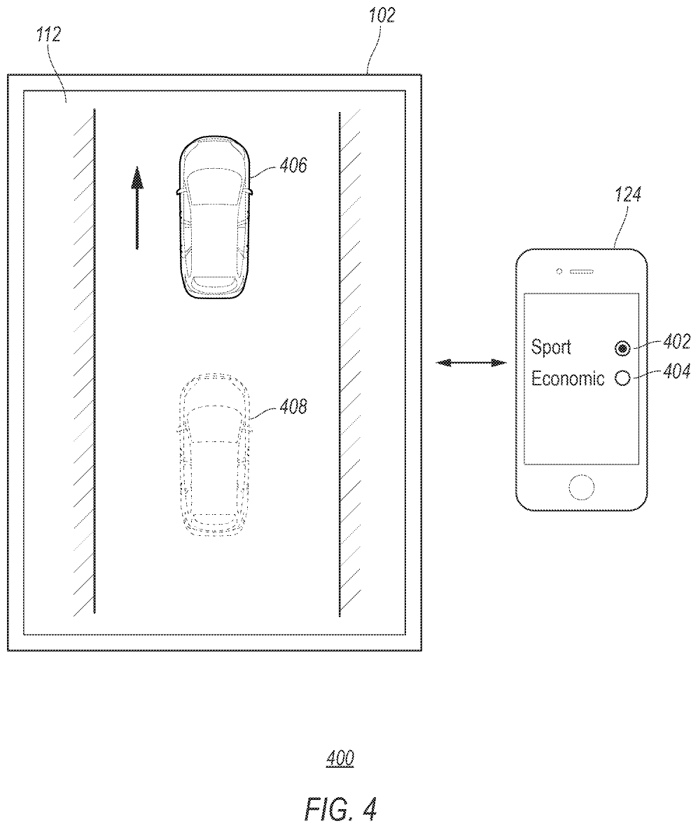

Referring to FIG. 4, an example diagram 400 of a vehicle acceleration simulation of one embodiment of the present disclosure is illustrated. With continuing reference to FIGS. 1-3, in the present example, the simulation system 100 allows the user to simulate a vehicle acceleration with different powertrain configuration for a same vehicle model. The mobile device 124 may be used to allow the user the select and switch between different trims of the vehicle. For instance, the mobile device 124 provide a sport trim option 402 and an economic trim option 404 for the user to select from. As indicated in FIG. 4, the sport trim is selected in the present example. The main display 112 of the computing device 102 may be used to display a simulated top view of the vehicles in comparison. A current vehicle 406 corresponding to the currently selected sport trim vehicle may be compared with a phantom vehicle 408 corresponding to the economic trim vehicle on the top view diagram to give the user an impression on how much faster the sport trim is as compared with the economic trim. The system may allow the user to switch vehicles at any time during the simulation using the interface displayed on the mobile device 124. Responsive to the user switching to the economic trim vehicle, the phantom vehicle 408 may be displayed in solid lines and the vehicle 406 corresponding to the sport trim vehicle may become the new phantom vehicle in dashed lines.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A server comprising:
a processor, programmed to,
responsive to a user selecting a vehicle for simulation, identify a minimum requirement and a preferred requirement for a plurality of features associated with the vehicle,
obtain information of user hardware including a computing device and a mobile device in communication with each other,
responsive to verifying the user hardware meets the preferred requirement for a first feature of the plurality of features, list the first feature on top of a feature list, and
responsive to the user selecting the first feature, perform a simulation of the first feature via the computing device and the mobile device.

2. The server of claim 1, wherein the user hardware further includes at least one of the computing device and the mobile device being associated with an input/output (I/O) device including at least one of a steering wheel, or a pedal, the processor is further programmed to:
perform the simulation of the first feature using a user input via the I/O device.

3. The server of claim 2, wherein the processor is further programmed to:
map simulation input controls to the I/O device, the computing device and the mobile device.

4. The server of claim 1, wherein the processor is further programmed to:
responsive to verifying the user hardware meets the minimum requirement and insufficient for the preferred requirement of a second feature, list the second feature on the list below the first feature.

5. The server of claim 1, wherein the processor is further programmed to:
generate a user review including an image of a simulation interface combined with a video and audio of the user captured via at least one of the computing device or the mobile device.

6. The server of claim 1, wherein the processor is further programmed to:
responsive to detecting selection of the vehicle to simulate, identify the plurality of features associated with the vehicle via a database.

7. The server of claim 1, wherein the processor is further programmed to:
responsive to verifying the user hardware is insufficient for the minimum requirement for a third feature, prohibit the third feature from being listed on the feature list.

8. The server of claim 1, wherein the processor is further programmed to:
output a first simulation interface via the computing device, and a second simulation interface via the mobile device.

9. The server of claim 8, wherein the first simulation interface is a front view of the vehicle, and the second simulation interface is a backup camera view.

10. The server of claim 8, wherein the first simulation interface is a top view of a first vehicle in comparison with a second vehicle, the second simulation interface is a control penal allowing the user to switch between the first vehicle and the second vehicle, the processor is further configured to responsive to receiving a user input via the second simulation interface to switch from the first vehicle currently being simulated to the second vehicle, switch view on the first interface to simulate the second vehicle.

11. A computing device, comprising:
a network controller programmed to communicate with a server;
a wireless transceiver programmed to communicate with a mobile device;
a human-machine interface (HMI); and
a simulation controller programmed to:
responsive to a user selecting, via the HMI, a vehicle to simulate, communicate with the server to identify a minimum requirement and a preferred requirement for a plurality of features associated with the vehicle,
examine user hardware information indicative of a specification of the computing device and the mobile device and compare the user hardware information with the minimum and preferred requirements,
responsive to verifying the user hardware information meets the preferred requirement for a first feature of the plurality of features, list the first feature on top of a feature list, and
responsive to the user selecting the first feature, perform a simulation of the first feature by outputting a first simulation interface via the HMI and a second simulation interface via the mobile device.

12. The computing device of claim 11, wherein the transceiver is further programmed to communicate with an input/output device, the simulation controller is further programmed to:
perform the simulation of the first feature using a user input via the I/O device.

13. The computing device of claim 12, wherein the simulation controller is further programmed to:
map simulation input controls to the I/O device, the HMI and the mobile device.

14. The computing device of claim 11, wherein the simulation controller is further programmed to:
generate a user review including an image of at least one of the simulation interfaces combined with a video and audio of the user captured via at least one of the computing device or the mobile device.

15. The computing device of claim 11, wherein the first simulation interface is a front view of the vehicle, and the second simulation interface is a surrounding-camera view.

16. The computing device of claim 11, wherein the first simulation interface is a top view of a first vehicle in comparison with a second vehicle, the second simulation interface is a control penal allowing the user to switch between the first vehicle and the second vehicle.

17. A method for a vehicle simulation system, comprising:
responsive to receiving an input from a user indicative of a selection a vehicle to simulate, identify a minimum requirement and a preferred requirement for a plurality of features associated with the vehicle;
obtaining information of user hardware including a computing device, a mobile device, and an input/output (I/O) device associated with the user;
comparing the user information with the minimum and preferred requirements;
responsive to verifying the user hardware meets the preferred requirement for a first feature of the plurality of features, listing the first feature on top of a feature list;
responsive to verifying the user hardware meets the minimum requirement and insufficient for the preferred requirement of a second feature, listing the second feature on the list below the first feature; and
responsive to the user selecting the first feature, performing a simulation of the first feature by receiving input via the I/O device, and outputting a first simulation interface via the HMI and a second simulation interface via the mobile device.

18. The method of claim 17, further comprising:
generating a user review including an image of at least one of the simulation interfaces combined with a video and audio of the user captured via at least one of the computing device or the mobile device.

19. The method of claim 17, wherein the first simulation interface is a front view of the vehicle, and the second simulation interface is a surrounding-camera view.

20. The method of claim 17, wherein the first simulation interface is a top view of a first vehicle in comparison with a second vehicle, the second simulation interface is a control penal allowing the user to switch between the first vehicle and the second vehicle.
